(19) United States
(12) Patent Application Publication
(10) Pub. No.: US 2006/0045035 A1
(43) Pub. Date: Mar. 2, 2006

(54) Power saving method for a wireless network communication device

(75) Inventor: Lin Liu, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/210,800

(22) Filed: Aug. 25, 2005

(30) Foreign Application Priority Data
Aug. 27, 2004 (TW) 93125936

(51) Int. Cl. G08C 17/00

(52) U.S. Cl. 370/311

(57) ABSTRACT

The present invention is a power saving method for wireless network communication which is applicable to wireless network equipment comprising of the following steps: receiving the frame in wireless network; getting the frame header in frame; according the frame header, judge whether the frames in channel is useful or not; if the received frame is useless, stopping receiving the left parts of the frame or the left frames; according to the frame header, calculating the duration time of left parts in the frame or the left frames; entering power saving status automatically; finally, returning to active status, after the channel is idle again.

### BACKGROUND OF THE INVENTION

1. Field of the Invention

The present invention relates to a power saving method for a wireless network communication device and, more particularly, to power saving method applicable to wireless network equipment.

2. Description of Related Art

In a distributed wireless network, such as an ANSI/IEEE 802.11, power management protocol can manage power consumption for wireless network equipment effectively. Wireless network equipment will be set to active mode when a station needs to receive or transmit data under the control of upper layer. On the contrary, the wireless network equipment is set to power save mode under the control of upper layer and wake up from power save mode periodically to receive a beacon.

However, this power management method depends on the control of upper layer and shall be available only when station doesn't want to transmit. In the distributed wireless network, such as wireless local area network (WLAN) base service set (BSS) of ANSI/IEEE 802.11, using carrier sense multiple access with a collision avoidance (CSMA/CA) medium sharing mechanism, once the station has contended for the channel, that station shall continue to transmit fragments until either all fragments of a single MSDU or MMPDU have been transmitted. At the same time, the stations that have failed to contend for the channel are also in active mode and shall receive every package transmitted in the channel till the channel is free. Then all the stations in this BSS shall start to contend for the channel again.

Further more, if the destination address (DA) in the frame header does not match with the medium access control address of the station, the duration field in this frame header will be used to update the network allocate vector (NAV) of the station. The other frames of the channel have nothing to do with the station during the frame end (equal to network allocate vector) time. The station knows these frames are useless in advance, but the station is in active mode. So it still receives these frames during this time.

FIG. 1 is a chart describing the method for wireless network communication of the prior art. A source station 16 transmits a require to send (RTS) 20 to a destination station 18 in order to inform other stations in the base service set (BSS) or independent base service set (IBSS), such as the station 10, that it has reserved a time section equaled to the network allocation vector (NAV) 12 provided by RTS 20 to transmit data. The destination station 18 that is addressed by RTS 20 shall send a clear to send (CTS) 26 after a short interframe space in order to allow the source station 16 transmitting. At the same time, the source station 16 has reserved a time section equaled to NAV 14 provided by CTS 26 to transmit the first data fragment 24.

The source station 16 receives the CTS 26 and sends the first data fragment 24 to the destination station 18 after a SIFS 22. At the same time, the source station 16 has reserved a time section equaled to NAV 86 provide by the first data fragment 24 to transmit the second data fragment 32. The destination station 18 receives the first data fragment 24 successfully and sends an acknowledgment (ACK) 28 to the source station 16 after a SIFS 22. At the same time, the source station 16 has reserved a time section equaled to NAV 88 provided by ACK 28 to transmit the second data fragment 32. The source station 16 receives the ACK 28 and transmits the second data fragment 32 to the destination station 18 after a SIFS 22.

The destination station 18 receives the second data fragment 32 successfully and sends an ACK 34 to the source station 16 after a SIFS 22. This transmission is now completed. All the stations in the BSS (or IBSS) now wait for a distributed interframe space (DIFS) 30 and start to contend for the channel.

For the stations in BSS or IBSS, such as the station 10, the received packages, including RTS 20, the first data fragment 24, CTS 26, ACK 28, the second data fragment 32 and ACK 34, are useless. So the power is wasted by receiving these useless frames.

### SUMMARY OF THE INVENTION

Because of several stations contending for a channel and only one station transmitting every time, most of stations shall be idle in active mode till channel is free. For the portable electronic equipment depending on battery, the power consumption of idle status will affect its available work time. So an improvement method that makes idle wireless network device into power save mode to reduce the power consumption of idle status is most desirable. The primary objective of the present invention is to provide an effective method to make idle wireless network device into power save mode to reduce the power consumption of idle status and to extend the available work time of portable electronic equipment.

To achieve the above objective, the present invention provides a power saving method for wireless network communication comprising of the steps of receiving the frame in wireless network; getting the frame header in frame; according the frame header, judge whether the frames in channel is useful or not; if the received frame is useless, stopping receiving the left parts of the frame or the left frames; according to the frame header, calculating the duration time of left parts in the frame or the left frames; entering power saving status automatically; returning to active status, after the channel is idle again.

### BRIEF DESCRIPTION OF THE DRAWINGS

The various objectives and advantages of the present invention will be more readily understood from the following detailed description when read in conjunction with the appended drawings, in which:

FIG. 1 is a chart of the method wireless network communication of prior art;

FIG. 2 is a format chart of the ANSI/IEEE 802.11 physical layer convergence protocol data unit (PPDU);

FIG. 3a is a format chart of the ANSI/IEEE 802.11 Management frame;

FIG. 3b is a format chart of the ANSI/IEEE 802.11 Data frame;

FIG. 4 is a station power saving chart for wireless network equipment of the present invention;

FIG. 5 is a another station power saving chart for wireless net work equipment of the present invention fitting for a simpler transmitting (No RTS/CTS); and

FIG. 6 is a power saving method flowchart for wireless network communication of the present invention.

### DETAILED DESCRIPTION OF PREFERRED EMBODIMENTS

Normally, the network protocol adopts a section parts transmit method for continuous pulsing to improve the throughput of the distributed wireless network. The source station will distribute the necessary data to several continuous frames and transmit them to the destination station continuously after it obtains the usufruct of channel. At the same time, via setting a time section in the frame header, the source station informs the other stations that it has reserved the time section to transmit. The other stations, which failed to obtain the usufruct of channel, receives these frames and be in backoff status till the source station finishes transmitting these continuous frames. Because of being in backoff status, these stations can not contend for the channel with the source station. So this transmittal isn't interrupted or interfered by the other stations. And the throughput is improved. However, a station still receives the useless frames in the channel till the backoff status ends. The next part uses ANSI/IEEE 802.11 as an example to describe how a station uses a new method to save power in this case in detail.

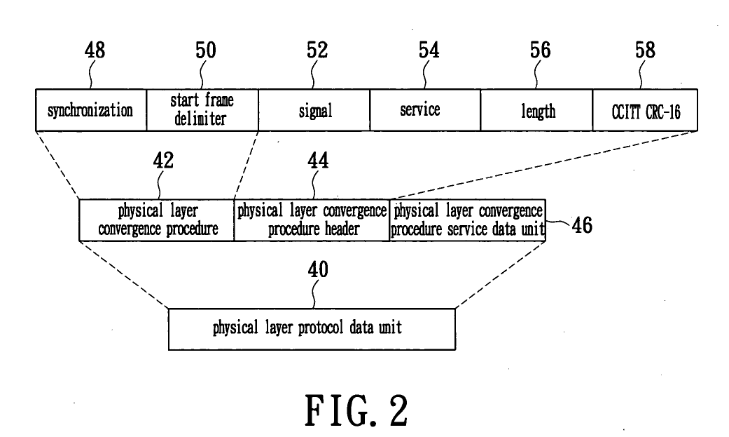

FIG. 2 shows the format for the ANSI/IEEE 802.11 physical layer protocol data unit (PPDU) 40 including the DSSS physical convergence procedure (PLCP) Preamble 42, the DSSS physical convergence procedure (PLCP) Header 44, and the physical convergence procedure service data unit (PSDU) 46. The PLCP Preamble 42 contains the following fields: Synchronization (Sync) 48 and Start Frame Delimiter (SFD) 50. The PLCP Header 44 contains the following fields: IEEE 802.11 Signaling (Signal) 52, IEEE 802.11 Service (Service) 54, LENGTH (Length) 56, and CCITT CRC-16 58.

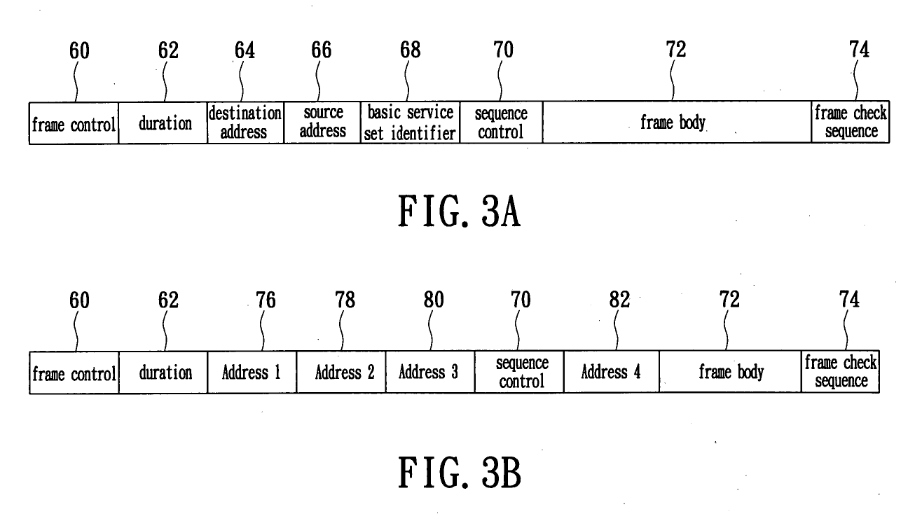

FIG. 3a is a format chart of the ANSI/IEEE 802.11 Management frame. The management frame contains the following fields: Frame Control 60, Duration 62, Destination Address (DA) 64, Source Address (SA) 66, a basic service set identifier (BSSID) 68, Sequence Control 70, Frame Body 72 and Frame Check Sequence (FCS) 74.

FIG. 3b is a format chart of the ANSI/IEEE 802.11 Data frame. The data frame contains the following fields: Frame Control 60, Duration 62, Address 1 76, Address 2 78, Address 3 80, Sequence Control 70, Address 4 82, Frame Body 72 and Frame Check Sequence (FCS) 74.

As shown in FIG. 3a and FIG. 3b, based on destination address 64, the station can decide whether the frame is useful. If the frame is useful, then the station continuously receives the remaining parts till the end; otherwise the station stops receiving, enters power save mode, closes the medium access control layer (MAC), the physical layer (PHY), the analog circuit and the RF circuit. Based on Signal 52, Service 54 and Length 56 of PLCP Header 44, the station can calculate the frame of continuous time. This time determines when the station will return from power save mode and enter active mode again.

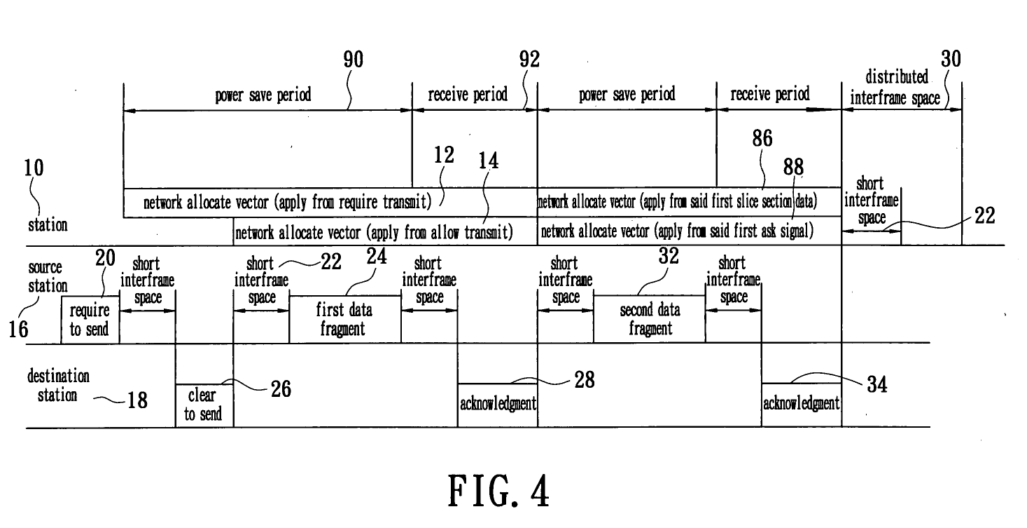

FIG. 4 is a station power saving chart for wireless network equipment of the present invention. For the station 10, all the frames in the first time section 36 and the second time section 38 are useless. The station 10 uses the Duration field of RTS 20 to update its NAV and enters a power save period 90 until the first data fragment 24 ends. The station 10 starts a normal receive period 92 and receive the ACK 28 after the power save period 90 ends.

The station 10 uses the Duration field of RTS 20 to update its NAV and enters a power save period 90 again until the second data fragment 32 ends. All of the data has been transmitted and the process is completed after the second data fragment 32 ends. So duration filed of the ACK 34 is zero. Then NAV of the station 10 updates to zero. This means the station 10 can contend for the channel again after the ACK 34 ends.

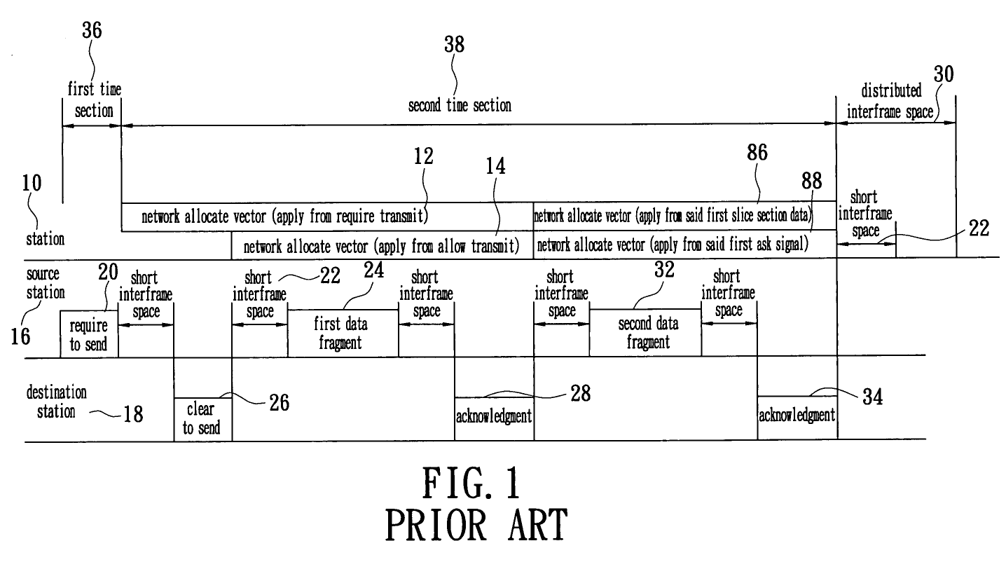

Comparing to the current power management, such as shown in FIG. 1, the new power save method decreases the power consumption of the station 10 obviously. During most of time in the second time section 38, the station 10, which adopts the new power save method, is in power save mode. However, if not a adopting it, the station 10 will be in active mode after failing to contend for the channel and spend lots of power in receiving the useless frames in the channel.

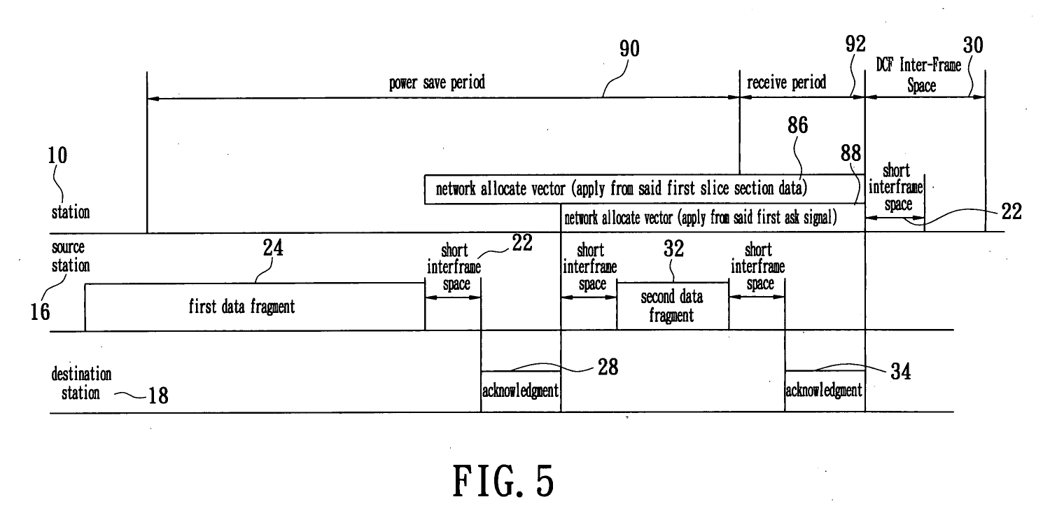

Sometimes, source station 16 does not transmit RTS 20 to destination station 18 before the first data fragment 24. And destination station 18 does not reply RTS 20 to source station 16, either. So station 10 can not update its NAV via receive duration field of RTS 20 or CTS 26 and then enter power save period 90. However, if station 10 wants to update its NAV via receive duration field of the first data fragment 24, the other problem will emerge. For checking the received frame, frame check sequence (FCS) appends at the end of frame. For example, in ANSI/IEEE 802.11, a double word CCITT CRC 32 FCS appends at the end of frame. The medium access control layer protocol uses the frame duration field to update its network allocation vector only after passing CRC-32 check. Station 10 has no time to enter power save period 90 after checking the first data fragment 24 via CRC-32 FCS. A simple solution is shown in FIG. 5. Station 10 only receives MAC Header of the first data fragment 24 and then enters power save period 90 directly. It uses duration field of the first data fragment 24 without CRC-32 check to update its NAV. This solution is a little risky because of no CRC-32 check. However, when saving power is prior, this solution is available.

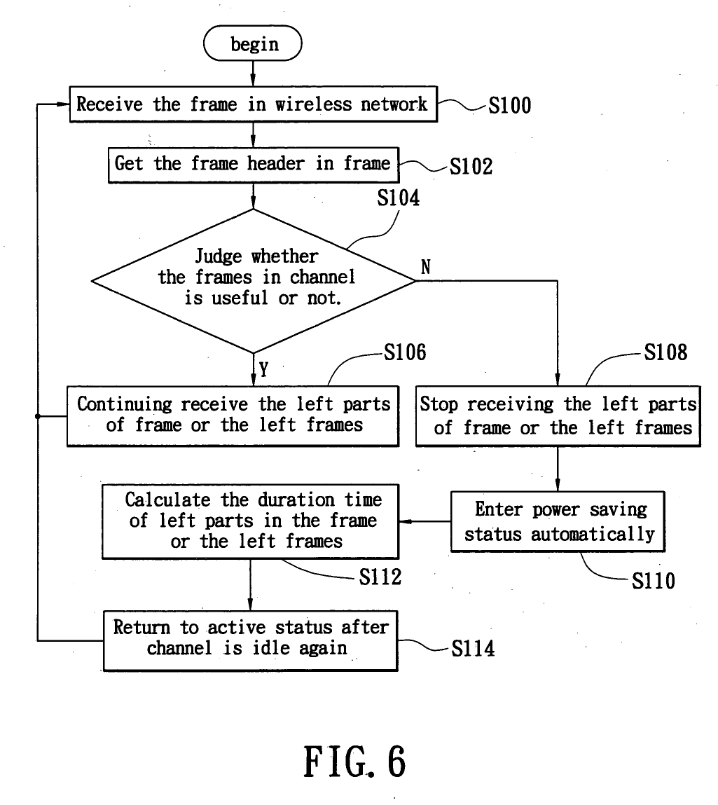

FIG. 6 is a flowchart of a power saving method for wireless network communication of the present invention. The method comprises of receiving a complex number frame in a wireless network (S100), getting the complex number frame header in the frames (S102), and the frame headers comprises of a frame rate field, a frame length field, a destination address, a duration time and a CRC 16 field. According to the frame headers, the station judges whether the received frame is useful or not (S104). If the received frame is useful, it will continue to receive the left parts of the frame (S106) until end and accomplish the corresponding operation, such as transmitting ACK frame to the source station. Then it will return to the active status and wait the frame signal in the wireless network (S100) and wait the next frame.

Otherwise, if the received frame is useless, the station will stop receiving the left parts of the frames (S108). As mentioned above, according to the frame headers, the station is able to calculate the duration time of left parts in the frame or the left frames (S112). The wireless network equipment will enter power saving status (S110) automatically. After a channel of the wireless network equipment is idle again, the station can return to active status (S114) and waiting the next frame (S100). The wireless network equipment is a medium access control layer, a physical layer, an analog circuit and a RF circuit.

The power saving method for wireless network communication lowers power consumption in wireless network equipment and allows users to work continuously for a longer period of time on the limited battery power provided.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power saving method for wireless network communication applicable to wireless network equipment, comprising the steps of:
receiving a complex number frame in a wireless network;
getting a complex number frame header in the complex number frame;
judging whether the complex number frame is useful or not in accordance with the complex number frame header;
changing the status of the wireless network equipment between active and power saving.

2. The power-saving method of wireless network communication as claimed in claim 1, wherein the complex number frame header comprises the frame rate, the frame length, the destination address.

3. The power-saving method of wireless network communication as claimed in claim 1, wherein, if the received frame is useful, the station will continue to receive the left parts of the frame until the end and accomplish the corresponding operation.

4. The power-saving method of wireless network communication as claimed in claim 1, wherein, if the received frame is useless, further comprises the steps of:
stop receiving the left parts of the complex number frame or the left of the complex number frame;
calculating the duration time of left parts in the complex number frame or the left of the complex number frame in accordance with the complex number frame header;
entering power saving status automatically; and
returning to active status, after a channel of the wireless network equipment is idle again.

5. The power-saving method of wireless network communication as claimed in claim 1, wherein the wireless network equipment consists of a medium access control (MAC) layer, a physical layer, an analog circuit and/or the RF circuit.
